(19) United States
(12) Patent Application Publication
(10) Pub. No.: US 2008/0197644 A1
(43) Pub. Date: Aug. 21, 2008

(54) Device and Method For Lifting a Layer of Stones

(75) Inventors: Hans Gebhart, Memmingen (DE); Martin Rothdach, Holzguenz (DE); Hermann Sauter, Tannheim (DE)

Correspondence Address: DAVIS BUJOLD & Daniels, P.L.L.C., 112 PLEASANT STREET, CONCORD, NH, 03301, US

(73) Assignee: BAUSTOFFWERKE GEBHART & SOHNE GMBH & CO. KG, Aichstetten (DE)

(21) Appl. No.: 11/915,187

(22) PCT Filed: May 9, 2006
(86) PCT No.: PCT/EP06/04291

§ 371 Date: Apr. 3, 2008

(30) Foreign Application Priority Data
May 21, 2005 (DE) 10 2005 023 487.9

(51) Int. Cl. B66C 1/02

(52) U.S. Cl. 294/64.1; 414/800

(57) ABSTRACT

A device for lifting a layer of stones, particularly of artificially aged cast concrete stones, clinker bricks or natural stones, comprises a vacuum device with a suction opening for drawing up the stones. The suction opening (4) obtains, by means of changeable template elements (5), a pattern consisting of closed and open suction areas (6,7). The created pattern is essentially adapted to the respective layer of stones (1) to be lifted, and concentrates the suction power of the vacuum device, in essence, onto the upper surfaces of the stones.

This is a national stage completion of PCT/EP2006/004291 filed May 9, 2006 which claims priority from German Application Serial No. 10 2005 023 487.9 filed May 21, 2005.

### FIELD OF THE INVENTION

The invention relates to a device for lifting a layer of stones.

The invention also relates to a method for lifting a layer of stones.

### BACKGROUND OF THE INVENTION

Stones, for example covering elements, facade elements, chalky sandstones, concrete stones, bricks or brick clinker, natural stones and the like, in particular concrete paving stones, are, as a rule, produced, further treated or retreated and stored in layer form. Transport from the factory to the customer also takes place, as a rule, in that the stones are stacked one above the other in layers.

In the case of large-format slabs, that is to say in the case of slabs in which, as a rule, four or six slabs give an area of one square meter, the use of a vacuum device for lifting these is known. The vacuum device in this case has individual suction elements which can be aligned directly with the slabs. The use of a large suction plate which is aligned with the four or six slabs is likewise possible. In this case, although some suction power between the slabs is lost or remains unused, this may be compensated, however, via a correspondingly high suction power, in such a way that the stones can nevertheless be lifted. There may be problems in lifting the large-format stones when these are heavily soiled.

A use of a vacuum device of this type is possible only in the case of large-format slabs. With normal concrete paving stones, which, as a rule, consist of small-format stones of various sizes, for example 20×20, 20×10, 17×17, 10×10 and the like, a vacuum device of this type cannot be used, since the loss of suction power occurring between the stones is so high that the stones can no longer be lifted reliably. One problem, inter alia, in this case is that the layers may consist continuously of stones of different size which, moreover, may be formed with different contours, for example square, rectangular, polygonal or round. The individual stone layers may also vary in their overall size and be formed per se from different stone formats, so that the proportion of “empty suction”, that is to say the region in which the suction port for the vacuum device does not meet any stone, is disproportionately high.

For the individual suction of small-format elements which are arranged in a layer, there are, outside the sector of stone manufacture, solutions which provide a suction plate with, for example, 100 or 200 ultra-small ports, each ultra-small port having a valve. The ultra-small ports, to which an element to be lifted is assigned, can be opened by means of the valves via corresponding electronics. The ultra-small ports not required are closed or switched off. However, solutions of this type, which may be operable in other branches of industry, cannot be employed in the sector of stone manufacture or are subject to high susceptibility to faults. In stone manufacture, particularly when the stones are reworked in order to lose their artificial appearance, a large quantity of dust occurs, with the result that valves and thin conduits rapidly become blocked and are therefore maintenance-intensive. So that solutions can be adopted in stone manufacture, they have to be correspondingly robust and unsusceptible to the environmental conditions arising during stone manufacture.

### SUMMARY OF THE INVENTION

The object on which the present invention is based, therefore, is to provide in a simple and cost-effective way a device and a method for lifting different layers of stones, in particular of small-format concrete paving stones.

By means of the template element, a pattern of closed and open suction regions is generated, which is adapted to the layer of stones to be lifted in each case, the suction power of the vacuum device being concentrated essentially onto the stone surfaces. In the regions in which no stone to be lifted stands opposite the suction port, closed regions are formed by the template element, so that no suction power is lost. Thus, even interspaces, between the stones and, if appropriate, even the marginal region of the stones can be closed correspondingly. What is therefore achieved in a simple way, without the use of valves correspondingly susceptible to faults and of a large number of ultra-small suction ports, is that even small-format stones in a layer of stones can be lifted reliably. A clearance which is present, if appropriate, between the stones can be maintained, since there is no need for the stones to be pushed together manually or hydraulically.

Since the template element is exchangeable, an appropriate template element can be delivered to the suction port in each case as a function of the layer of stones to be lifted, thus, in turn, generating a pattern of closed and open suction regions which is adapted essentially to the layer of stones to be lifted, and concentrating the suction power correspondingly onto the stone surfaces.

A single vacuum device is therefore sufficient to lift a multiplicity of different layers of stones reliably, both in terms of their overall layer size and in terms of the size and circumference of the individual stones. Even stones or layers of stones with special formats can be lifted in a simple way.

It is particularly advantageous that the template elements can be adapted continuously to the different layers of stones. The production process is therefore not disrupted.

Although countless variants of stone formats are known on the market, most stone layers can nevertheless be lifted or lifted off within a specific production operation by means of ten to fifteen template elements. The number of different template elements can therefore be limited to an economically expedient amount.

In the manufacture of stones, particularly in the manufacture of concrete paving stones, the cycle rate or a high production speed is of particular importance. It is therefore advantageous to change the template elements as quickly as possible.

It is advantageous if a plurality of template elements are wound up on an unwinding and winding device. The unwinding and winding device may in this case cooperate with the vacuum device in such a way that in each case the template element corresponding to the layer of stones to be lifted can be delivered to the suction port.

In a structural refinement, there may in this case be provision for the unwinding and winding device to have at each of the two opposite ends of the suction port a roll for unwinding and winding up the template elements.

The rolls may be provided, for example, directly on the vacuum device, on a lifting and transport device connected to the vacuum device or on a separate holding device.

This solution makes it possible to change the template elements particularly quickly and reliably, with the result that a pattern of closed and open suction regions which corresponds to the layer to be lifted can be produced. After one stone layer has been set down and before a further stone layer is picked up anew, the new template element may in this case already be delivered, for example, by means of a corresponding reeling mechanism. Changing the template element therefore does not require an additional amount of time. In principle, any material which may be provided with corresponding passage ports for forming the open suction regions and is suitable for being wound onto a roll or the like may be considered as a template element for the unwinding and winding device. A multiplicity of materials are suggested for this purpose from the general prior art. Sheets, preferably plastic sheets, are suitable in a particularly advantageous way, since these can have a correspondingly thin and nevertheless tear-resistant configuration. The template elements may also be formed, if appropriate, from microcellular rubber, preferably with fabric inserts. It is also possible for the microcellular rubber to be provided additionally with an airtight sheet.

If the template element is formed solely from a sheet, it has proved to be advantageous to provide the underside of the suction port with a flexible surface matching the stone surface. In this case, for example, microcellular rubber may be employed. A flexible surface on the underside of the suction port has the advantage that unevennesses on the stone surface are compensated and the suction port can be matched or snugly fitted, flush, to the stone surfaces. Furthermore, the microcellular rubber makes good sealing possible.

The general prior art suggests a multiplicity of variants which, on the one hand, ensure reliable pressing onto the stone surface and, on the other hand, allow good sealing for focusing the suction power.

In a development of the invention, there is provision, furthermore, for the individual template elements to be connected releasably to one another. A releasable connection of the individual template elements of the unwinding and winding device has the advantage that, if one template element is damaged, this can be detached and replaced by a new template element. There is therefore no need to exchange the entire unwinding and winding device.

In a structural development of the invention, so that a rapid change of the template elements can be ensured and in view of the different layers of stones which usually have to be lifted, there is provision for two to twenty, preferably five to fifteen template elements to be wound onto the unwinding and winding device. Furthermore, there is provision for the unwinding and winding device to be capable of being changed by means of a quick-action fastening.

In a structural solution alternative to the unwinding and winding device, there may be provision for the template elements to be produced in board form, for example from plastic or metal. The suction port may in this case be provided, for example, with a drawer for receiving the board-shaped template elements. Alternatively or additionally to this, there may also be provision for the board-shaped template elements to be connected magnetically to the suction port. In this case, there may be provision for the vacuum device to be provided with an electromagnet which, after the delivery of the correspondingly magnetically attractable template element, is activated and is deactivated again in order to change the template element.

Alternatively to this, various other possibilities for connecting a board-shaped element to the suction port may be envisioned by a person skilled in the art.

The template elements may be stored in a quick-change device which is preferably positioned spacially close to the vacuum device. A multiplicity of solutions for making it possible to carry out a rapid and reliable exchange of the template elements are known from the sector of tool-changing devices. For example, this could also take place as is customary with CD changers.

Irrespective of the structural implementation of the template elements, there may be provision, according to the invention, for the template elements in each case to have an identification key or code. The code (for example, a barcode) may preferably be recognized or read by a sensor, so that the appropriately provided template element is delivered to the suction port either as a result of an additional automatic recognition of the next layer of stones to be lifted or by means of manual actuation.

It is advantageous if the suction port is provided with a grid. This affords suitable bearing support for the template elements, without the suction power being appreciably influenced.

### BRIEF DESCRIPTION OF THE DRAWINGS

Two exemplary embodiments of the invention are illustrated below, in principle, by means of the drawing in which:

FIG. 1 shows a basic illustration of the device according to the invention from the side, with an unwinding and winding device, before a layer of stone is lifted;

FIG. 2 shows a view of the underside of a template element;

FIG. 3 shows a basic illustration according to FIG. 1, a layer of stones being sucked up or lifted;

FIG. 4 shows a view of the device according to the invention in the direction of the arrow IV of FIG. 3; and

FIG. 5 shows an embodiment, structurally alternative to FIG. 1, of the device according to the invention, the template element having a board-shaped design.

### DETAILED DESCRIPTION OF THE INVENTION

According to the invention, any stones, for example covering elements, facade elements, chalky limestones, bricks or brick clinker or natural stones, can be lifted, regardless of their material constitution. The lifting of stones 1 which are formed as concrete paving stones is presented below by means of the exemplary embodiments. The invention, of course, is not restricted to these.

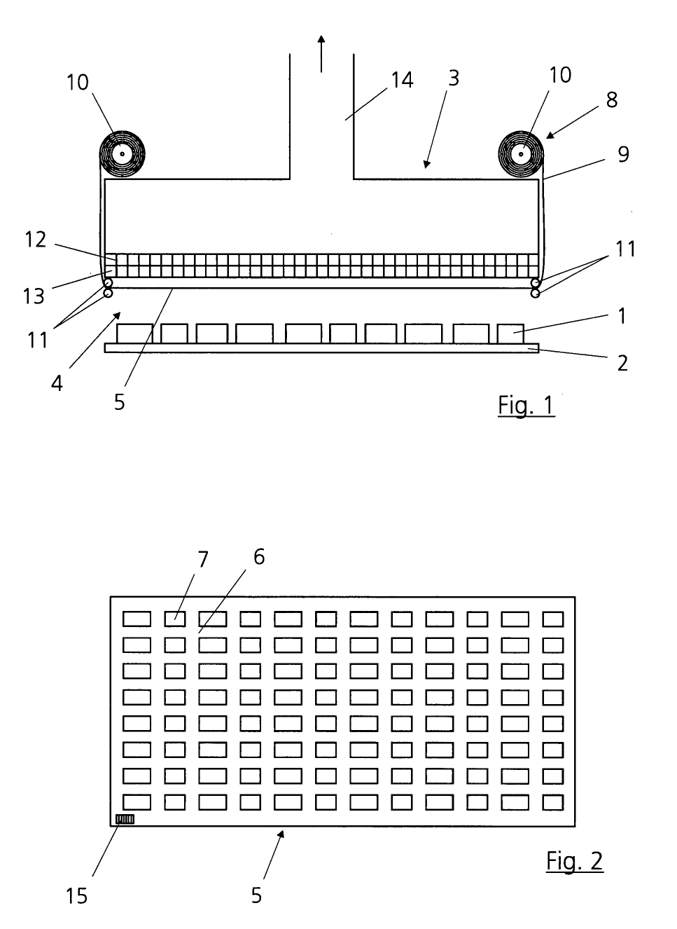

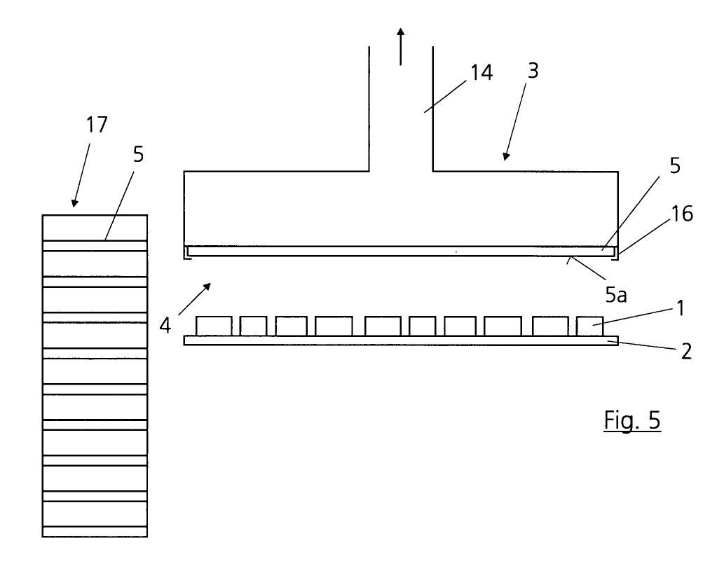

The production of concrete paving stones 1 is sufficiently known, and it is therefore not dealt with in any more detail below. The concrete paving stones 1 leave the production plant generally in a production position, that it to say in an arrangement in which a multiplicity of concrete paving stones 1 are arranged next to one another in a single layer. A production position of this type is illustrated by way of example from below in FIG. 4 and from the side in FIGS. 1 and 5.

The concrete paving stones 1 are located on a base 2 during the production, further-processing and reworking process and also often during storage. This may be a panel-shaped base or a production belt.

The solution according to the invention may be employed both during the production process in order to shift a layer of stones 1 and in order to stack a plurality of stone layers one above the other, so as to deliver these to the customers. The solution according to the invention is particularly suitable in combination with devices for the artificial aging of stones, such as are known, for example, from DE 20 2004 020 206, EP 0 860 258 B2 and DE 20 2004 015 348. In these devices for the artificial aging of stones, it is particularly advantageous if the stones have a clearance with respect to one another. Such a clearance between the concrete paving stones 1 is not lost on account of the solution according to the invention.

As is evident from FIG. 1, the device according to the invention for lifting concrete paving stones 1 has a vacuum device 3 with a suction port 4 in order to suck up the concrete paving stones 1. The suction port 4 in this case acquires a pattern of closed and open suction regions 6, 7 by means of an exchangeable template element 5. The pattern generated is adapted essentially to the layer of stones to be lifted in each case.

FIG. 2 shows one possible pattern of closed and open suction regions 6, 7 which may occur due to corresponding ports or perforations in the template element 5. As is evident in comparison with FIG. 4, concrete paving stones 1 arranged with a clearance with respect to one another can be lifted by means of the open suction regions 7 arranged at a distance from one another.

By means of the pattern, the suction power of the vacuum device 3 is concentrated essentially onto the stone surfaces of the concrete paving stones 1. According to FIGS. 1 to 4, the template elements 5 are wound onto an unwinding and winding device 8. The unwinding and winding device 8 in this case cooperates with the vacuum device 3 or with a production control in such a way that the template element 5 corresponding to the layer of concrete paving stones 1 to be lifted is delivered in each case to the suction port 4. In the exemplary embodiment, there is provision for five to fifteen template elements 5 to be wound onto the unwinding and winding device 8. The template elements 5 are produced, in the exemplary embodiment, as a plastic sheet, the unwinding and winding device 8 having at each of two opposite ends of the suction port 4 a roll 10 for winding up or unwinding the template elements 5. To minimize wear, the sheet is guided at suitable points by guide rollers 11.

As is evident from FIG. 1, the vacuum device 3 is provided on its suction port 4 with a grid 12. Moreover, the suction port 4 has on its underside a flexible surface which is suitable for being matched to the stone surfaces, which may perfectly well have elevations or depressions of, for example, 5 to 10 mm (0.197 to 0.394 in.). In the exemplary embodiment, the flexible surface 13 of the suction port 4 is formed from microcellular rubber and has a structure which virtually does not reduce the suction power. The flexible surface 13 may, for example, have a grid structure.

As is evident from FIG. 1, the vacuum device 3 is connected to a lifting and transport device 14.

FIG. 1 shows the device according to the invention before the vacuum device 3 is activated and the concrete paving stones 1 are sucked up by the open suction regions 7.

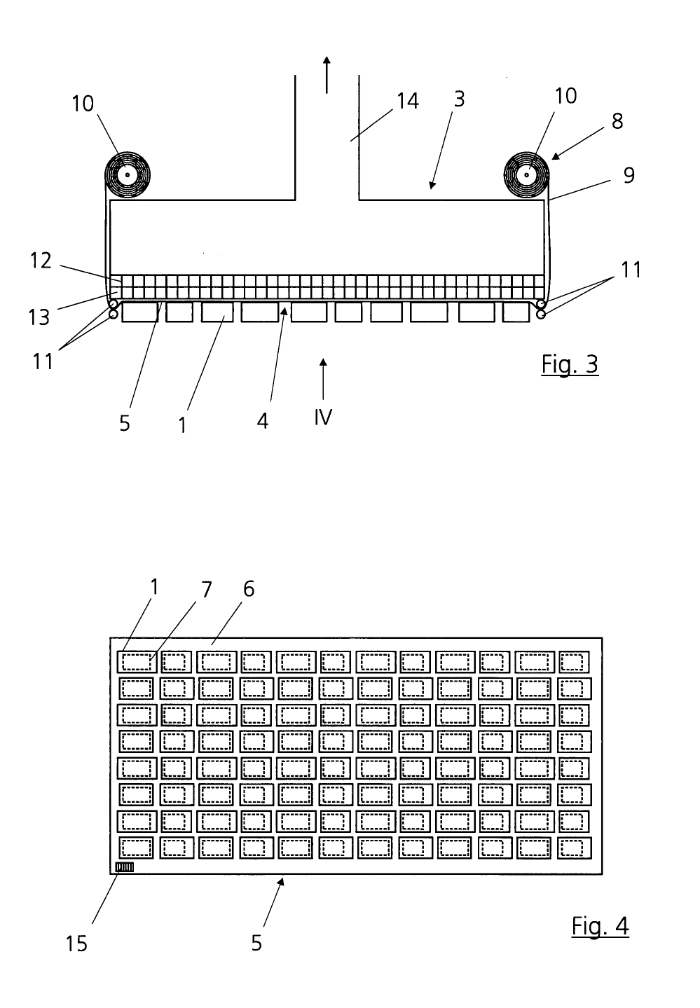

FIG. 3 shows an illustration according to FIG. 1, the vacuum device 3 being switched on and the concrete paving stones 1 being sucked onto the open suction regions 7.

FIG. 4 shows an illustration according to FIG. 3 from below, from which it is clear that, in the exemplary embodiment, the open suction regions 7 are smaller than the stone surfaces of the concrete paving stones 1, with the result that the power loss of the vacuum device 3 is minimized. The open suction regions 7 are illustrated by dashed lines in FIG. 4. The suction port 4 of the vacuum device 3 is covered by the closed suction regions 6 in such a way that the suction power of the vacuum device 3 is concentrated onto the stone surfaces of the concrete paving stones 1.

The pattern formed by the closed suction regions 6 and by the open suction regions 7 is dependent on the layer of concrete paving stones 1 which is to be lifted.

In principle, any layers of stones may be lifted by means of the device according to the invention, while the individual stones may have different sizes, formats and contours.

FIG. 2 shows an individual template element S in a view from below, with closed suction regions 6 and with open suction regions 7. As is evident, furthermore, from FIG. 2 and FIG. 4, in the exemplary embodiment each template element 5 has an identification key 15. In the exemplary embodiment, the identification key 15 can be read by a sensor device, not illustrated in any more detail, and may be formed, for example, as a barcode. The layer of concrete paving stones 1 which is to be lifted can thus be assigned the corresponding template element 5 manually or automatically. The identification key 15 does not in this case necessarily have to be arranged directly on the respective template element 5. For example, the identification key 15 may also be arranged between two template elements 5 or on another template element 5, if this proves to be more suitable in terms of readability by a sensor device.

FIG. 5 shows a refinement alternative to FIGS. 1 to 4, the template elements 5 being produced in board form, and in the exemplary embodiment from metal. The vacuum device 3 or the suction port 4 is in this case provided with a drawer 16 for receiving a board-shaped template element 5. FIG. 5 may be identical (with the exception of the unwinding and winding device 8 being dispensed with) to the device according to the invention already described in FIG. 1. As a result of the vacuum device 3 being activated, the template element 5 pushed into the drawer 16 is sucked onto the suction port 4 and therefore bears closely against the latter.

The underside of the pushed-in template element 5, that is to say the side facing the stone surfaces, may be formed from or provided with a flexible, elastic or soft material, so that it can be matched or snugly fitted to the rough or uneven stone surfaces, with the result that gaps between the stone surfaces and the template element 5, as a result of which the power of the vacuum device 3 is reduced, are avoided.

Alternatively or additionally to the drawer 16, the vacuum device 3 or the suction port 4 may also be provided with a magnet, which allows the board-shaped template element 5 to adhere magnetically to the suction port 4.

For the rapid exchange of the board-shaped template elements 5 during the production process, in the exemplary embodiment a quick-change device 17 is provided in which a plurality of template elements 5 are arranged.

1-21. (canceled)

22. A device for lifting a layer of stones with a vacuum device having a suction port for sucking up the stones, a template for generating a pattern of closed and open suction regions capable of being arranged on the suction port, at least one template element (5) being provided, which in each case having patterns matched to the layer of stones (1), the at least one template element (5) being capable of being delivered to the suction port (4) and being matched to the layer of stones (1) to be lifted, such that a closed suction region is formed by the at least one template element (5) essentially in regions in which no stone (1) to be lifted stands opposite the suction port (4), in order to cover the suction port (4) of the vacuum device (3) in such a way that the suction power of the vacuum device (3) is concentrated onto the surface of the stones (1) by open suction regions (7) of the at least one template element (5).

23. The device as claimed in claim 22, wherein the at least one template element (5) is wound up on an unwinding and winding device (8).

24. The device as claimed in claim 23, wherein the unwinding and winding device (8) cooperates with the vacuum device (3) such that in each case the at least one template element (5) corresponds to the layer of stones (1) to be lifted is delivered to the suction port (4).

25. The device as claimed in claim 23, wherein the unwinding and winding device (8) has, at each of two opposite ends of the suction port (4), a roll for unwinding and winding up the template elements (5).

26. The device as claimed in claim 23, wherein a plurality of template elements (5) are releaseably connected to one another.

27. The device as claimed in claim 22, wherein the at least one template element (5) is formed from at least one of a sheet (9) and a micro-cellular rubber.

28. The device as claimed in claim 27, wherein the micro-cellular rubber is reinforced with fabric inserts.

29. The device as claimed in claim 22, wherein the suction port (4) has, on an underside, a flexible surface matchable to a surface of a stone surface.

30. The device as claimed in claim 23, wherein between two to twenty template elements (5) are wound onto an unwinding and winding device (8).

31. The device as claimed in claim 23, wherein the unwinding and winding device (8) is connected to one of the vacuum device (3) and another holding device by a quick-action fastening.

32. The device as claimed in claim 22, wherein the at least one template element (5) is produced in board form.

33. The device as claimed in claim 32, wherein the at least one template element (5) is formed from one of plastic and metal.

34. The device as claimed in claim 32, wherein the suction port (4) is provided with a drawer (16) for receiving a board-shaped template element (5).

35. The device as claimed in claim 32, wherein the board-shaped template elements (5) are magnetically connected to the suction port (4).

36. The device as claimed in claim 32, wherein the at least one template element (5) is stored in a quick-change device (17).

37. The device as claimed in claim 22, wherein each of the at least one template element (5) is assigned an identification key (15).

38. The device as claimed in claim 37, wherein the identification key (15) is read by a sensor device.

39. The device as claimed in claim 37, wherein the layer of stones (1) to be lifted is one of automatically and manually assigned to the corresponding template element (5).

40. The device as claimed in claim 22, wherein the suction port (4) has a grid (12).

41. The device as claimed in claim 22, wherein the vacuum device (3) is connected to a lifting and transport device (14).

42. A method for lifting a layer of stones with a vacuum device which via a suction port which sucks up the stones to be lifted, the method comprising the steps of:
matching a template element (5) to the layer of stones (1) to be lifted;
delivering the template element (5) to a suction port (4) such that a closed suction region (6) of the template element (5) is essentially located in regions where no stone (1) to be lifted is opposite the suction port (4); and
positioning the closed suction region (6), covering the suction port (4) of the vacuum device (3), such that open suction regions (7) concentrate suction power of the vacuum device (3) essentially onto a surface of the stones (1) to be lifted.
